(19) United States
(12) Patent Application Publication
(10) Pub. No.: US 2026/0227939 A1
(43) Pub. Date: Aug. 6, 2026

(54) STORAGE MEDIUM STORING APPLICATION PROGRAM, METHOD, AND INFORMATION PROCESSING APPARATUS

(71) Applicant: CANON KABUSHIKI KAISHA, Tokyo (JP)

(72) Inventor: TAKANOBU SUZUKI, Kanagawa (JP)

(21) Appl. No.: 19/457,673

(22) Filed: Jan. 23, 2026

(30) Foreign Application Priority Data
Feb. 3, 2025 (JP) 2025-016154

(51) Int. Cl. G06F 3/12

(52) U.S. Cl. CPC G06F 3/1253; G06F 3/1205; G06F 3/1228; G06F 3/1285

(57) ABSTRACT

A non-transitory computer-readable storage medium storing an application program, a method being executed by executing the application program by a computer of an information processing apparatus, the method comprising supporting a standard driver provided by a provider of an operating system of the information processing apparatus, the standard driver generating print data which is printable by printers of a plurality of printer makers, and causing a display of the information processing apparatus to perform display of a screen for receiving a setting of a time for printing standby to be performed after start of printing based on the print data.

### BACKGROUND

### Field of the Technology

The present disclosure relates to a storage medium storing an application program, a method, and an information processing apparatus.

### Description of the Related Art

A configuration, which uses a printer driver that has been installed on an information processing apparatus as control software for a printing apparatus to issue a printing instruction to the printing apparatus connected to the information processing apparatus, has been known. An operating system (hereinafter, referred to as “an OS”), which is basic software, has been installed on the information processing apparatus, and the printer driver is configured in accordance with specifications defined by the OS and operates (runs) by being invoked from the OS. On the other hand, a manufacturer that provides the printing apparatus is able to provide a printer driver that conforms to the specifications of the OS, thereby providing a means for instructing the printing apparatus to perform printing by using the OS. It should be noted that in the present disclosure, the term “manufacturer” includes a vendor of the printing apparatus.

Furthermore, in recent years, Windows (registered trademark) has provided a standard class driver (hereinafter, also referred to as “a standard driver”) that is capable of being commonly used among printing apparatuses provided by a plurality of manufacturers. The standard driver is bundled with the package of the OS, and is capable of being easily used by connecting any printing apparatus to the information processing apparatus. Therefore, if the standard driver is available, a user does not need to separately install a model-specific printer driver suited to a printing apparatus, and therefore the standard driver is highly convenient. In addition, the standard driver is configured to be able to set print functions in accordance with print device capabilities (hereinafter, also referred to as “PDC”) generated based on information obtained from the connected printing apparatus. As a result, the user who uses the standard driver is able to set print functions in accordance with the capabilities of the connected printing apparatus, even though the user uses one standard driver.

In addition, the standard driver is capable of being associated with an application for function extension (hereinafter, referred to as “an extension application”). The extension application is capable of being provided by the manufacturer that provides the printing apparatus. The extension application is capable of providing functions that are not capable of being realized by the standard driver alone (extended functions) by editing the PDC that has been generated by the standard driver. In this regard, Japanese Laid-Open Patent Publication (kokai) No. 2021-33526 discloses a technique for performing function extension by using an extension application that has been associated with a standard driver so as to be able to realize manufacturer-specific functions such as a poster print function and a binding print function.

Incidentally, in a printing apparatus known as an inkjet printer, in the case where sheet discharging is continuously performed, if a sheet discharging interval time is shorter than a drying time for ink on a sheet surface (a paper sheet surface), malfunctions may occur, such as the ink on the sheet surface (the paper sheet surface) staining another sheet surface (another paper sheet surface) or sheets (paper sheets) sticking together due to the ink. In addition, in the case where double-sided printing is performed with respect to paper sheets with weak stiffness, if a time between the end of printing on the front side and the start of printing on the back side is short, a malfunction that the paper sheets jam in the printing apparatus may occur.

Therefore, for example, in the case of performing printing of an image with high ink usage, the user is able to predict that there is a high possibility that the malfunctions described above will occur if the printing of the image with high ink usage becomes printing of a plurality of print pages. However, in printing using the standard driver, even if an extension application is associated with the standard driver, there has been an issue in that the user is unable to perform a setting for avoiding the occurrence of the malfunctions described above.

### SUMMARY

The present disclosure provides a storage medium storing an application program that allows to perform a setting for avoiding the occurrence of malfunctions due to printing using a standard driver becoming printing of a plurality of print pages, a method, and an information processing apparatus.

Accordingly, a first aspect of the present disclosure provides a non-transitory computer-readable storage medium storing an application program, a method being executed by executing the application program by a computer of an information processing apparatus, the method comprising supporting a standard driver provided by a provider of an operating system of the information processing apparatus, the standard driver generating print data which is printable by printers of a plurality of printer makers, and causing a display of the information processing apparatus to perform display of a screen for receiving a setting of a time for printing standby to be performed after start of printing based on the print data.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of a printing system.

FIGS. 2A and 2B are block diagrams that each illustrates a software configuration of the printing system.

FIGS. 3A, 3B and 3C, are diagrams that illustrate data formats handled by respective components of the printing system.

FIG. 4 is a diagram that illustrates an example of a print setting screen.

FIG. 5 is a sectional view that illustrates a schematic configuration of a printing apparatus.

FIG. 6 is a sectional view of the printing apparatus when a roll sheet is cut by a cutter unit.

FIG. 7 is a block diagram that illustrates a hardware configuration of the printing apparatus.

FIG. 8 is a flowchart when a print setting screen extending unit of an extension application performs the display of the print setting screen.

FIG. 9 is a flowchart for illustrating a processing performed by the printing apparatus.

### DESCRIPTION OF THE EMBODIMENTS

The present disclosure will now be described in detail below with reference to the accompanying drawings showing embodiments thereof.

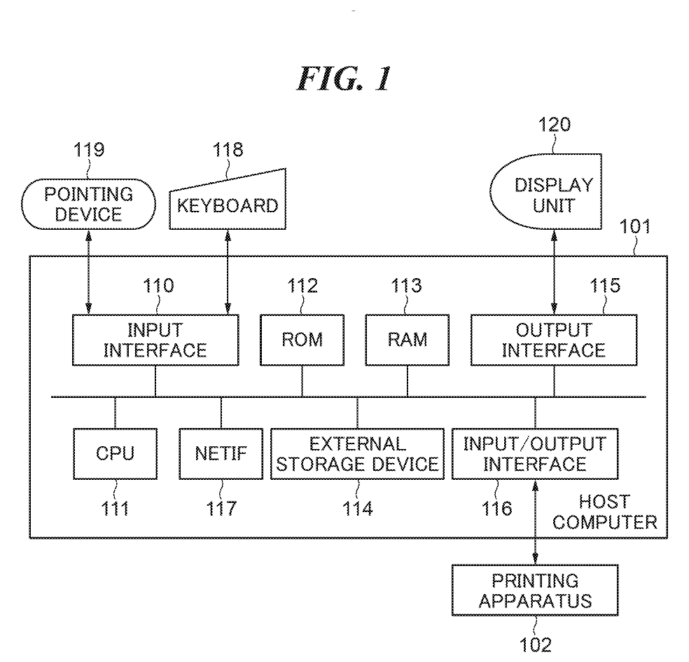

Hereinafter, an embodiment of the present disclosure will be described in detail with reference to the drawings. However, the configuration described in the present embodiment below is merely an example, and the scope of the present disclosure is not limited by the configuration described in the present embodiment. For example, each unit (each component) constituting the present disclosure can be replaced with a unit (a component) with any configuration that can perform the same function(s). In addition, any component(s) may be added. Furthermore, any two or more configurations (features) of the present embodiment can be combined. Hereinafter, the present embodiment will be described with reference to FIGS. 1 to 9. It should be noted that the same components are denoted by the same reference numerals and the description thereof will be omitted.

### Hardware configuration of printing system

FIG. 1 is a block diagram that illustrates a hardware configuration of a printing system. As shown in FIG. 1, the printing system includes a host computer 101 and a printing apparatus 102. The host computer 101 includes an input interface 110, a central processing unit (a CPU) 111, a read only memory (a ROM) 112, a random access memory (a RAM) 113, an external storage device 114, an output interface 115, an input/output interface 116, and a NETIF 117. Input devices such as a keyboard 118 and a pointing device 119 are connected to the input interface 110, and a display device such as a display unit 120 is connected to the output interface 115.

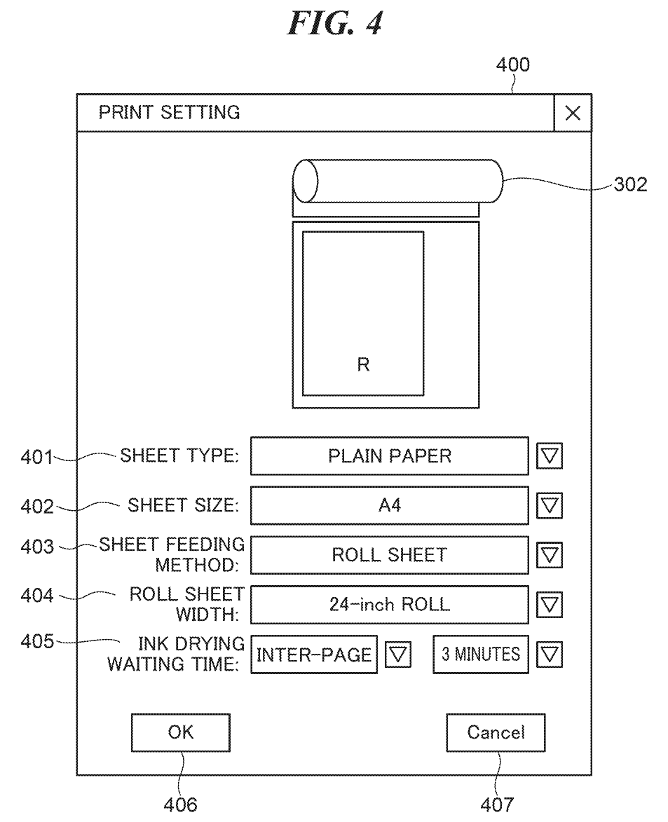

The ROM 112 stores an initialization program. The RAM 113 is used as a working memory or the like when various kinds of programs stored in the external storage device 114 are executed. The external storage device 114 stores an application program group (a group of application programs), an operating system (an OS), print data generation software, and other various kinds of data. In the present embodiment, the CPU 111 (a computer) executes processing according to the procedure (steps) of the program that has been stored in the external storage device 114, thereby realizing respective functions described below in the host computer 101 and performing processes shown in the flowchart. In this way, the various kinds of programs become capable of running within the host computer 101. An output device such as the printing apparatus 102 is connected to the input/output interface 116. The NETIF 117 is a network interface, and performs control for performing data transfer with an external device (not shown) via a network (not shown). The display unit 120 displays, for example, a print setting screen shown in FIG. 4, which will be described below.

It should be noted that the host computer 101 (an information processing apparatus) may be a desktop type personal computer, a smartphone, a note type personal computer (a laptop computer), or a tablet terminal. The printing apparatus 102 is an inkjet printer that executes printing by ejecting ink onto a sheet surface (a paper sheet surface), but may be a printer that executes printing by using another method (for example, an electrophotographic method using toner). Sheets (paper sheets) supported by the printing apparatus 102 include a roll sheet (a roll paper sheet), which is wound around a roll paper tube, and cut sheets (cut paper sheets), which have been cut in advance. The following description will focus on the case where the printing apparatus 102 performs printing on a roll sheet. In addition, the printing apparatus 102 may be a multifunction peripheral (an MFP) including a plurality of functions such as copying, printing, and faxing. In addition, although the host computer 101 and the printing apparatus 102 are configured separately, they may be configured as one information processing apparatus.

### Software configuration of printing system

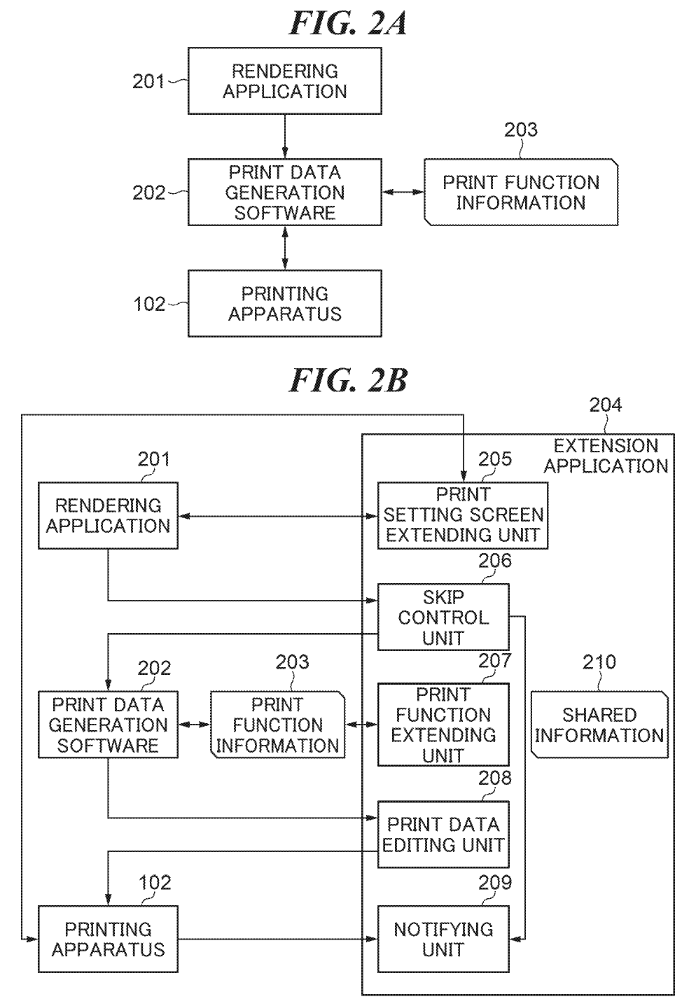

FIGS. 2A and 2B are block diagrams that each illustrates a software configuration of the printing system. Here, the description will be given on the premise that the printing system uses the host computer 101 which is equipped with Microsoft (registered trademark) Windows (registered trademark) 10 (or a version greater than 10) as its OS. FIG. 2A shows a rendering application 201, print data generation software 202, and print function information 203, as a general configuration of the software configuration of the printing system. FIG. 2B shows an extension application 204 in addition to the general configuration of the software configuration of the printing system shown in FIG. 2A.

In other words, FIG. 2A is a diagram that illustrates a general configuration in the case where the extension application 204 has not been associated with the print data generation software 202 and the printing apparatus 102. On the other hand, FIG. 2B is a diagram that illustrates a configuration in the case where the extension application 204 has been associated with the print data generation software 202 and the printing apparatus 102. It should be noted that the rendering application 201, the print data generation software 202, the print function information 203, and the extension application 204 have been stored in the external storage device 114 of the host computer 101.

[Software configuration of printing system in the case where the extension application 204 has not been associated]

First, the software configuration of the printing system in the case where the extension application 204 has not been associated with the print data generation software 202 and the printing apparatus 102 will be described with reference to FIG. 2A. The rendering application 201 is software that creates contents to be printed (rendering data). The rendering application 201

corresponds to, for example, a document creation application, a spreadsheet application, or the like. When the rendering application 201 receives a printing request from a user, the rendering application 201 issues a printing instruction to the OS. The printing instruction includes print setting information for instructing the operations of the print data generation software 202 and the printing apparatus 102. The print setting information is also referred to as “a print ticket”.

In order to output the print setting information, the rendering application 201 is capable of causing to display a print setting screen provided by any one of the print data generation software 202, the OS, and the rendering application 201. The print setting screen includes setting items (hereinafter, referred to as “control items”) that allow the user to set print functions according to capability information from the print data generation software 202 (information capable of being set as a print setting), and control items that indicate setting values of the setting items. The capability information is also referred to as “print capabilities” (hereinafter, also referred to as “PC”).

The print data generation software 202 is a software program capable of generating print data that is capable of being printed with a plurality of printing apparatuses provided by different manufacturers. The print data generation software 202 determines (decides) the PC based on the print function information 203. The print function information 203 is data indicating all print functions that are capable of being set by the user, setting values of the all print functions, and print functions in which exclusive relationships between the setting values have been described. The print function information 203 is also referred to as “print device capabilities (PDC)”. The print function information 203 is included in a configuration file of the print data generation software 202 and is stored in the external storage device 114 as an unchangeable file.

Alternatively, the print function information 203 is capable of being dynamically generated by the print data generation software 202 or the like. Specifically, a configuration may be adopted in which the print data generation software 202 or the OS obtains attribute data of the printing apparatus 102 from the printing apparatus 102, and generates the print function information 203 in accordance with attribute information within the obtained attribute data. It should be noted that in the case where the print function information 203 is dynamically generated, it is possible to edit the generated print function information 203. In addition, the attribute data of the printing apparatus 102 is a response obtained by issuing a “Get-Printer-Attributes” operation of the internet printing protocol (the IPP) to the printing apparatus 102. This response includes attribute information indicating functions that are capable of being set in the printing apparatus 102 (capabilities of the printing apparatus), and setting values related to the attribute information. This response is stored in the RAM 113.

With such a configuration, the print data generation software 202 is capable of being configured to allow the user to set print functions that are capable of being used in a printing apparatus connected to the host computer 101 depending on the connected printing apparatus. In other words, even in the case where a printing apparatus with different functions or a printing apparatus developed by a different manufacturer is connected to the host computer 101, the print data generation software 202 is capable of being configured to allow the user to set available print functions depending on the connected printing apparatus.

Here, a configuration will be described in which an IPP Class Driver included in Windows (registered trademark) 10 has been used as the print data generation software 202. The IPP Class Driver is a printer driver that executes a printing processing according to the specifications of a standard printing protocol called the internet printing protocol (the IPP), and is bundled with the package of the OS. The IPP Class Driver is not a unique printer driver depending on the model of the printing apparatus 102, but a standard class driver that is capable of being commonly used among a plurality of printing apparatuses. In other words, the print data generation software 202 is a standard driver provided by Microsoft, which is the provider of Windows (registered trademark) 10 that is the OS. In addition, the IPP Class Driver obtains capability information of the connected printing apparatus102 and generates the print function information 203 based on the capability information of the printing apparatus102 that has been obtained, so that the user is able to set print functions supported by the connected printing apparatus102.

The OS generates intermediate data (hereinafter, also referred to as “input data”) based on the printing instruction that has been issued by the rendering application 201 and transmits the generated intermediate data to the print data generation software 202. It should be noted that the data that the rendering application 201 outputs for printing is data in a Graphic Device Interface format (GDI format data), or data in an XML Paper Specification format (XPS format data). Here, a case where the IPP Class Driver is used as the print data generation software 202 is assumed. In this case, if the data output by the rendering application 201 is GDI format data, the OS converts the GDI format data output from the rendering application 201 into XPS format data. Furthermore, the OS transmits the converted XPS format data to the print data generation software 202 as the intermediate data. On the other hand, if the data output by the rendering application 201 is XPS format data, the OS transmits the XPS format data output from the rendering application 201 to the print data generation software 202 as the intermediate data.

It should be noted that the intermediate data includes rendering data, which is information about an image to be formed on a sheet surface (a paper sheet surface), and the print setting information that has been set by the user. The print data generation software 202 converts the received intermediate data into print data that is capable of being interpreted by the printing apparatus 102, and transmits the converted print data to the printing apparatus 102. It should be noted that the print data includes the rendering data, which is the information about the image to be formed on a sheet surface (a paper sheet surface), and print setting attribute information, which has been generated based on the print setting information that has been set by the user (attribute information for setting a print setting). The print setting attribute information includes the attribute information indicating the functions that are capable of being set in the printing apparatus 102 (the capabilities of the printing apparatus), and the setting values related to the attribute information.

The printing apparatus 102 performs printing on the sheet surface (the paper sheet surface) based on the print data that has been transmitted from the print data generation software 202. At this time, the printing apparatus 102 forms the rendering data included in the print data on the sheet surface (the paper sheet surface) by performing an operation in accordance with the print setting attribute information included in the print data. The print setting attribute information includes attribute information for setting print quality (image quality priority, speed priority, or the like), double-sided printing, etc., and setting values of the attribute information. For example, in the case where the print setting attribute information includes attribute information designating (setting) double-sided printing and a setting value indicating that double-sided printing is to be performed, the printing apparatus 102 executes double-sided printing.

### Software configuration of printing system in the case where the extension application 204 has been associated

Next, the configuration of the printing system in the case where the extension application 204 has been associated with the print data generation software 202 and the printing apparatus 102 will be described with reference to FIG. 2B. It should be noted that configurations and processes not specifically mentioned below are the same as those in FIG. 2A. The extension application 204 (an application program) is software for extending the functions of the print data generation software 202, and is software that is not included in the OS in advance (is not bundled with the OS).

Therefore, the user needs to operate the host computer 101 to download the extension application 204 from a server (not shown) via the Internet to the host computer 101 and install the extension application 204 on the host computer 101. Alternatively, the extension application 204 may be automatically installed on the host computer 101 upon that the printing apparatus 102 is connected to the host computer 101. Specifically, in the case where the printing apparatus 102 is connected to the host computer 101, the OS obtains device identification information from the printing apparatus 102. Furthermore, the OS downloads the extension application 204 corresponding to the obtained device identification information from the server via the Internet to the host computer 101 and installs the extension application 204 corresponding to the obtained device identification information on the host computer 101. In other words, the print data generation software 202 and the extension application 204 are stored in the host computer 101 as separate files. It should be noted that the extension application 204 may be installed on the host computer 101 by the extension application 204 stored in a storage medium being read by the CPU 111 of the host computer 101.

It should be noted that the print data generation software 202 and the extension application 204 may be updated and upgraded, but the update processing of the print data generation software 202 and the update processing of the extension application 204 are also performed at different timings. In other words, the timing at which the print data generation software 202 is obtained from the host computer 101 and the timing at which the extension application 204 is obtained from the host computer 101 are different. In addition, a trigger for obtaining the print data generation software 202 from the host computer 101 is also different from a trigger for obtaining the extension application 204 from the host computer 101. It should be noted that in the case where the extension application 204 has been installed on the host computer 101, the OS associates the extension application 204 with the print data generation software 202 and the printing apparatus 102.

As shown in FIG. 2B, the extension application 204 includes a print setting screen extending unit 205, a skip control unit 206, a print function extending unit 207, a print data editing unit 208, and a notifying unit 209. In addition, the extension application 204 includes shared information 210 that is capable of being commonly accessed from each unit of the print setting screen extending unit 205, the skip control unit 206, the print function extending unit 207, the print data editing unit 208, and the notifying unit 209. The actual state of the shared information 210 is a file that has been stored in the external storage device 114 of the host computer 101 or information that has been stored in the RAM 113 of the host computer 101. The extension application 204 performs writing and reading out information into and from the shared information 210 by using an application program interface (an API) provided by the OS.

In addition, the extension application 204 is capable of handling information indicating an ink drying waiting time (hereinafter, referred to as “ink drying waiting time information”). The ink drying waiting time refers to a time during which the printing apparatus 102 stands by without performing a printing operation (that is, a time during which the printing apparatus 102 performs printing standby) for a time that has been set as the ink drying waiting time, in the middle of forming a printed matter (printed sheets). In the printing apparatus 102, after the ink on the sheet surface (the paper sheet surface) has dried due to the ink drying waiting time, an operation of feeding the roll sheet (the roll paper sheet) being printed and an operation of cutting the roll sheet (the roll paper sheet) that has already been printed are performed. Therefore, by performing the setting for the ink drying waiting time, it is possible to expect that the effect of improving the fixation of the ink on the roll sheet (the roll paper sheet) and the effect of preventing the sheets (the paper sheets) from sticking together are achieved. The ink drying waiting time information is information that is capable of being applied to all printing apparatuses that are capable of being supported by the extension application 204. It should be noted that in the case where the print function information 203 that has been generated based on the attribute data or the capability information of the printing apparatus 102 includes information about the ink drying waiting time, the extension application 204 may use the print function information 203 as it is without using the ink drying waiting time information.

It should be noted that the extension application 204 may terminate its operation each time the processing of one of the print setting screen extending unit 205, the skip control unit 206, the print function extending unit 207, the print data editing unit 208, and the notifying unit 209 ends. In this case, the OS will start up the extension application 204 every time the OS receives a request to use one of the print setting screen extending unit 205, the skip control unit 206, the print function extending unit 207, the print data editing unit 208, and the notifying unit 209. In addition, other configurations may be adopted. For example, when the processing of the print setting screen extending unit 205 ends, the OS causes to terminate the operation of the extension application 204, but even when the processing of the skip control unit 206 ends, the OS may leave the extension application 204 running. Furthermore, the extension application 204 may cancel the processing of one of the print setting screen extending unit 205, the skip control unit 206, the print function extending unit 207, the print data editing unit 208, and the notifying unit 209 during the processing of one of the print setting screen extending unit 205, the skip control unit 206, the print function extending unit 207, the print data editing unit 208, and the notifying unit 209. In the case where the processing has been cancelled, a job being processed in a print queue is deleted by the OS.

When the rendering application 201 receives a printing request from the user, the rendering application 201 issues a printing instruction to the OS. Even with the configuration of FIG. 2B, as with the configuration of FIG. 2A, the rendering application 201 is capable of causing to display a print setting screen. However, in the configuration of FIG. 2B, a print setting screen provided by the extension application 204 is displayed. Specifically, a print setting screen provided by the print setting screen extending unit 205 of the extension application 204 is displayed. It should be noted that whether the print setting screen provided by the print setting screen extending unit 205 is displayed or not depends on the user's operation. It should be noted that the print setting screen provided by the print setting screen extending unit 205 will be described in detail with reference to FIG. 4, which will be described below.

In addition, when the rendering application 201 receives the printing request from the user and issues the printing instruction to the OS, the OS starts up the skip control unit 206. The skip control unit 206 controls whether or not to skip the processing of the print data generation software 202. It should be noted that the skip control unit 206 is not capable of obtaining the intermediate data and the print setting information. After the skip control unit 206 is started up, the OS generates intermediate data based on the printing instruction output from the rendering application 201, and transmits the generated intermediate data to the print data generation software 202.

In this case, if the skip control unit 206 does not skip the processing of the print data generation software 202, the intermediate data is processed by the print data generation software 202 into print data that is capable of being interpreted by the printing apparatus 102, and then is transmitted to the print data editing unit 208. On the other hand, if the skip control unit 206 skips the processing of the print data generation software 202, the intermediate data is transmitted to the print data editing unit 208 without being processed by the print data generation software 202. As a result, the print data editing unit 208 becomes capable of processing the intermediate data.

It should be noted that the case where it is preferable for the skip control unit 206 to skip the processing of the print data generation software 202 is, for example, a case where it is desirable for the print data editing unit 208 to perform an enlargement/reduction processing. Specifically, the intermediate data to be retained in a vector format suffers less deterioration when enlarged or reduced compared to the intermediate data to be retained in a raster format. For this reason, in the case where the print data generation software 202 outputs an image in the raster format, the skip control unit 206 skips the processing of the print data generation software 202, and the print data editing unit 208 performs the enlargement/reduction processing with respect to the intermediate data. The print data editing unit 208 edits the intermediate data that has been transmitted from the print data generation software 202 or the print data that has been processed by the print data generation software 202. As a result, the intermediate data that has been transmitted from the print data generation software 202 becomes the print data.

Here, as an example of editing performed by the print data editing unit 208, roll sheet width expansion will be described. The print data editing unit 208 changes the enlargement or reduction of the intermediate data or the print data based on the print setting information for the roll sheet width expansion that has been received from the OS and information about a roll sheet width of the actually-set roll sheet, which has been obtained from the printing apparatus 102. In addition, the print data editing unit 208 is able to display a user interface screen (a UI screen) on the display unit 120. As a result, the print data editing unit 208 is able to display the layout result of the intermediate data or the print data as a preview screen.

The print data editing unit 208 transmits the print data that has been obtained by editing the intermediate data or the print data that has been obtained by editing the print data to the printing apparatus 102 via the OS. The printing apparatus 102 performs printing on the roll sheet (the roll paper sheet) based on the received print data. It should be noted that in the case where the processing of the print data generation software 202 has been skipped by the skip control unit 206, the print data editing unit 208 may convert the received intermediate data into print data that is capable of being interpreted by the printing apparatus 102.

The print function extending unit 207 is able to edit the print function information 203 that has been generated by the print data generation software 202 or the OS. As a result, the print function extending unit 207 is able to perform the addition of functions provided by the extension application 204, and the addition of functions that are supported by the printing apparatus 102 but not supported by the print data generation software 202. Furthermore, the print function extending unit 207 is able to perform the addition of the exclusive relationships between the setting values of the print functions, and the like. The OS starts up the print function extending unit 207 when the extension application 204 has been first associated with the printing apparatus 102 and the print data generation software 202. Furthermore, the OS may start up the print function extending unit 207 at another timing (for example, when the OS is started up). In this way, in the case where an optional device is added to the printing apparatus 102 later and a printing-related function is extended, the print function extending unit 207 is able to detect the extended printing-related function and add the extended printing-related function to the print function information 203. It should be noted that examples of such an optional device include a two-stage roll unit and a finisher.

The notifying unit 209 is able to display a notification to the user in response to an error occurring in the printing apparatus 102. For example, when a sheet-out error (a paper-out error) occurs in the printing apparatus 102, the print data generation software 202 detects the occurred error, and the OS uses a notifying function called a toast notification, which is the function of the OS, to cause the display unit 120 display a message. When the user selects this toast notification by using the pointing device 119 or the like, the notifying unit 209 is invoked from the OS, and a UI screen of the notifying unit 209 is displayed. The notifying unit 209 is able to display on the UI screen of the notifying unit 209, for example, a detailed message regarding the sheet-out error, a sheet filling method, etc.

It should be noted that once the extension application 204 has transmitted the print data to the printing apparatus 102, it is not possible to perform the screen display of a guide or the like associated with the print data in the middle of the processing of one of the print setting screen extending unit 205, the skip control unit 206, the print function extending unit 207, the print data editing unit 208, and the notifying unit 209. In addition, the configuration of the extension application 204 is not limited to including all of the functions (the units) described above, but may include only some of the functions (the units) described above or may include other functions. In addition, the extension application 204 may be simply referred to as “printing software”.

As described above, it can be said that the extension application 204 includes at least one of the following functions. The first function is a function to display the print setting screen (the print setting screen extending unit 205). The second function is a function to control whether or not to skip the processing of the print data generation software 202 (the skip control unit 206). The third function is a function to edit the print data to be input into the printing apparatus 102 (the print data editing unit 208). The fourth function is a function to extend the functions that are capable of being set by the print data generation software 202 (the print function extending unit 207). The fifth function is a function to display the UI screen in response to an error occurring in the printing apparatus 102 (the notifying unit 209).

### Format of print data handled by respective components of printing system

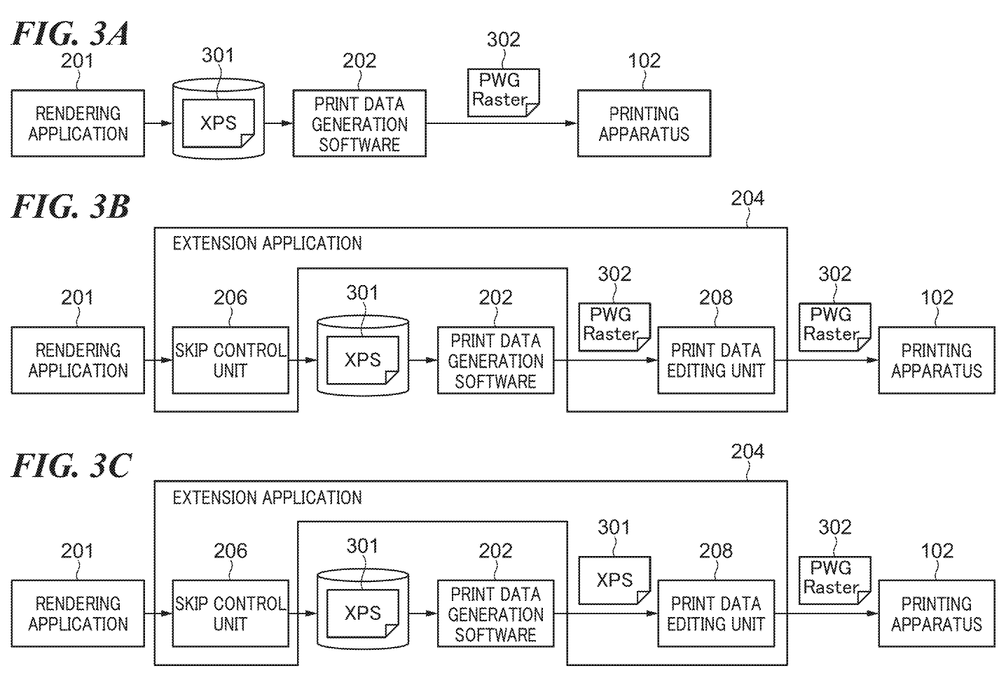

The print data generation software 202 obtains the attribute data or the capability information from the printing apparatus 102, and determines the format of the print data supported by the printing apparatus 102. As a result, the print data generation software 202 becomes able to generate the print data that is capable of being interpreted by the printing apparatus 102. It should be noted that the format of the print data described below may also refer to the format of the rendering data included in the print data. FIGS. 3A, 3B and 3C are diagrams that illustrate data formats handled by the respective components of the printing system.

FIG. 3A is the diagram that illustrates the data formats handled by the respective components of the printing system in the case where the extension application 204 has not been associated with the print data generation software 202 and the printing apparatus102. As shown in FIG. 3A, when the OS receives the printing instruction from the rendering application 201, the OS generates XPS format data 301 that is the intermediate data, and transmits the generated XPS format data 301 to the print data generation software 202. The print data generation software 202 converts the received XPS format data 301 into print data that is capable of being interpreted by the printing apparatus 102. At this time, the print data generation software 202 determines the format of the print data supported by the printing apparatus 102, based on the attribute data or the like that has been obtained from the printing apparatus 102. As a result, the print data generation software 202 becomes able to convert the XPS format data 301 into print data that is capable of being interpreted by the printing apparatus 102.

Examples of the format of the print data include portable document format (PDF) and PWG Raster format, but the format of the print data is not limited to PDF or PWG Raster format. In the present embodiment, it is assumed that PWG Raster format is used as the format of the print data supported by the printing apparatus 102. Therefore, the print data generation software 202 converts the XPS format data 301 into PWG Raster format data 302. Furthermore, the print data generation software 202 transmits the PWG Raster format data 302 to the printing apparatus 102. The printing apparatus 102 performs printing based on the PWG Raster format data 302 that has been transmitted from the print data generation software 202.

FIG. 3B is the diagram that illustrates the data formats handled by the respective components of the printing system in the case where the extension application 204 has been associated with the print data generation software 202 and the printing apparatus102 and the processing of the print data generation software 202 has not been skipped. As shown in FIG. 3B, when the OS receives the printing instruction from the rendering application 201, the OS starts up the skip control unit 206 of the extension application 204. It should be noted that in the case of FIG. 3B, the skip control unit 206 does not skip the processing of the print data generation software 202.

As a result, in the same manner as in the case of FIG. 3A, the print data generation software 202 converts XPS format data 301, which is the intermediate data, into PWG Raster format data 302. The print data editing unit 208 receives the PWG Raster format data 302 as input data. The PWG Raster format data 302 is print data that is capable of being interpreted by the printing apparatus 102. Therefore, the print data editing unit 208 transmits the PWG Raster format data 302 in its original format, which is the input data, to the printing apparatus102. The printing apparatus 102 performs printing based on the PWG Raster format data 302 that has been transmitted from the print data editing unit 208.

FIG. 3C is the diagram that illustrates the data formats handled by the respective components of the printing system in the case where the extension application 204 has been associated with the print data generation software 202 and the printing apparatus102 and the processing of the print data generation software 202 has been skipped. As shown in FIG. 3C, when the OS receives the printing instruction from the rendering application 201, the OS starts up the skip control unit 206 of the extension application 204. At this time, the skip control unit 206 issues, to the OS or the print data generation software 202, a skip instruction to not perform a conversion processing from the intermediate data into the print data. When the print data generation software 202 receives the skip instruction from the skip control unit 206, the print data generation software 202 transmits the intermediate data, which is XPS format data 301, to the print data editing unit 208 of the extension application 204 without converting the XPS format data 301 into the print data.

The print data editing unit 208 performs necessary editing with respect to the XPS format data 301 based on the print setting information, and then converts the XPS format data 301, with respect to which the necessary editing has been performed, into PWG Raster format data 302. The print data editing unit 208 transmits the PWG Raster format data 302, which is the print data, to the printing apparatus 102. The printing apparatus 102 performs printing based on the PWG Raster format data 302 that has been transmitted from the print data editing unit 208. It should be noted that in the case where the XPS format is included in data formats that are capable of being interpreted by the printing apparatus 102, the print data editing unit 208 is also able to transmit the XPS format data directly to the printing apparatus 102 without converting the XPS format data into another data format.

### Print setting screen display processing performed by the print setting screen extending unit 205

FIG. 4 is a diagram that illustrates an example of the print setting screen. A print setting screen 400 shown in FIG. 4 is an example of the case where the printing apparatus 102 supports a roll sheet (a roll paper sheet) and a cut sheet (a cut paper sheet) as a printing medium (a printing sheet), and is displayed on the display unit 120 of the host computer 101 by the print setting screen extending unit 205 of the extension application 204. The print setting screen 400 is a UI screen for the user to perform settings for respective print functions of the printing apparatus 102, which are capable of being set by the print data generation software 202. A preview screen of the PWG Raster format data 302 is displayed on the print setting screen 400. Reference numerals 401 to 405 indicate control items for the user to perform the settings for the respective print functions. The sheet type setting 401 is a control item that allows the user to set a type (for example, plain paper, recycled paper, or the like) of a printing medium on which the print data will be printed. The sheet size setting 402 is a control item that allows the user to set a size (for example, A4, B5, or the like) of the printing medium on which the print data will be printed.

The sheet feeding method setting 403 is a control item that allows the user to set a sheet feeding method (for example, “roll sheet” or “cut sheet”) for the printing medium on which the print data will be printed. It should be noted that the sheet size setting 402 becomes capable of being set when the user has set “cut sheet” in the sheet feeding method setting 403. Therefore, in the case where the user has set “roll sheet” in the sheet feeding method setting 403, the sheet size setting 402 is hidden (for example, the sheet size setting 402 is grayed out). The roll sheet width setting 404 is a control item that allows the user to set a width of a roll sheet on which the print data will be printed. The roll sheet width setting 404 becomes capable of being set when the user has set “roll sheet” in the sheet feeding method setting 403. Therefore, in the case where the user has set “cut sheet” in the sheet feeding method setting 403, the roll sheet width setting 404 is hidden (for example, the roll sheet width setting 404 is grayed out).

The ink drying waiting time setting 405 (a setting related to the printing standby) is a control item that allows the user to set the ink drying waiting time, that is, is a control item that allows the user to set the time during which the printing apparatus 102 performs the printing standby in the middle of forming the printed matter (the printed sheets). The ink drying waiting time setting 405 includes a setting for a mode for the printing standby and a setting for a time for the printing standby. In the ink drying waiting time setting 405 shown in FIG. 4, as the setting for the mode for the printing standby, a setting for inter-page (between pages) has been set, and as the setting for the time for the printing standby, a setting for “3 minutes” has been set. In addition to the inter-page, examples of the mode for the printing standby include inter-scan (between scans) and printing apparatus setting priority.

The inter-page refers to a mode in which the printing apparatus 102 performs the printing standby while a print page shifts to the next print page. In more detail, in the case where “roll sheet” has been set in the sheet feeding method setting 403, this mode (the inter-page) may be a mode in which the printing standby is performed between a time when cutting of the roll sheet ends and a time when the next cutting starts, or may be a mode in which the printing standby is performed between a time when sheet discharging of the roll sheet ends and a time when the next sheet discharging starts. The former is capable of being expected to achieve the effect of preventing sheets after cutting from sticking together and the effect of preventing a sheet after cutting from staining another sheet after cutting. The latter is capable of being expected to achieve the effect of preventing roll sheets having become long length, which have not been cut after being discharged, from overlapping each other and becoming dirty or sticking together. It should be noted that hereinafter, the mode indicated by the inter-page will be described as the mode in which the printing standby is performed between the time when cutting of the roll sheet ends and the time when the next cutting starts.

In addition, in the case where “cut sheet” has been set in the sheet feeding method setting 403, the mode indicated by the inter-page may be a mode in which the printing standby is performed while printing shifts to a different cut sheet, or may be a mode in which the printing standby is performed while printing shifts from one surface of a cut sheet to the other surface (in the case of double-sided printing). The former is capable of being expected to achieve the effect of preventing sheets after printing from sticking together and the effect of preventing a sheet after printing from staining another sheet after printing. In addition to the effects described above, the latter is capable of being expected to achieve the effect of preventing sheets from jamming during double-sided printing.

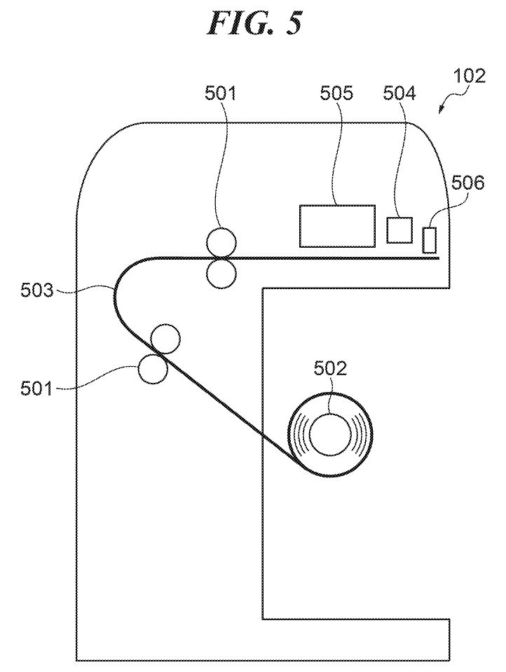

The inter-scan refers to a mode in which the printing standby is performed while scanning of an inkjet head (denoted by a reference numeral 505 in FIG. 5, which will be described below) of the printing apparatus 102 shifts to the next scanning. It should be noted that when the printing apparatus setting priority is set as the setting for the mode for the printing standby, the mode for the printing standby that has been set on the side of the printing apparatus 102 is used preferentially even if a setting by the ink drying waiting time setting 405 is performed.

In the case where the inter-page has been set as the setting for the mode for the printing standby, in addition to “3 minutes”, examples of the time for the printing standby include “30 seconds”, “1 minute”, “30 minutes”, and the printing apparatus setting priority. In addition, in the case where the inter-scan has been set as the setting for the mode for the printing standby, examples of the time for the printing standby include “0.5 seconds”, “1 second”, “3 seconds”, “5 seconds”, “7 seconds”, “9 seconds”, and the printing apparatus setting priority. It should be noted that when the printing apparatus setting priority is set as the setting for the time for the printing standby, the time for the printing standby that has been set on the side of the printing apparatus 102 is used preferentially even if a setting by the ink drying waiting time setting 405 is performed.

An OK button 406 is a button that allows the user to confirm the settings on the print setting screen 400. A cancel button 407 is a button that allows the user to cancel the settings on the print setting screen 400.

### Configuration of the printing apparatus 102

FIG. 5 is a sectional view that illustrates a schematic configuration of the printing apparatus 102. FIG. 5 shows a portion of the configuration of the printing apparatus 102 that is involved in conveying a roll sheet. In more detail, FIG. 5 shows a positional relationship at a location where a roll sheet 503, which is conveyed from a roll paper tube 502 along a conveying path by conveying rollers 501 in the printing apparatus 102, is measured by an optical sensor 504 provided at a position opposite a platen. The inkjet head 505 prints an image by ejecting ink onto the roll sheet 503 that has been conveyed from the roll paper tube 502 while moving in a main scanning direction.

When performing sheet feeding, the printing apparatus 102 lifts the roll sheet 503 wound around the roll paper tube 502 onto the platen by the conveying rollers 501. At this time, the optical sensor 504 measures a thickness and a width of the roll sheet 503 in addition to the intensity of specular reflection light and the intensity of diffuse reflection light from the roll sheet 503. The printed roll sheet 503 is cut by a cutter unit 506 to a length desired by the user. It should be noted that the above-described configuration of the printing apparatus 102 is merely an example, and the printing apparatus 102 is not limited to the above-described configuration. In addition, the sheet capable of being printed on by the printing apparatus 102 is not limited to the roll sheet 503, and as described above, a cut sheet is also available, but a description of a portion that is involved in conveying a cut sheet will be omitted.

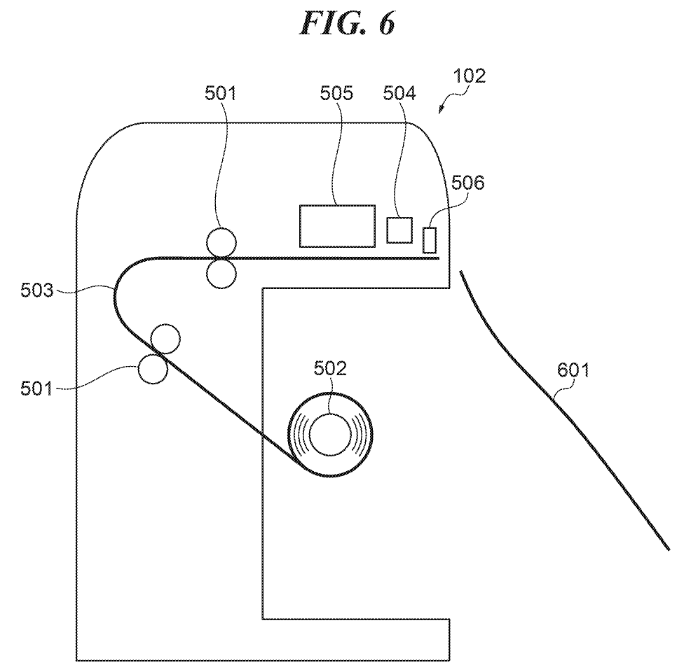

FIG. 6 is a sectional view of the printing apparatus 102 when the roll sheet 503 is cut by the cutter unit 506. It should be noted that in the description of FIG. 6, it is assumed that the inter-page has been set as the mode for the printing standby in the ink drying waiting time setting 405. While forming a printed matter, the printing apparatus 102 enters a printing standby state based on the setting in the ink drying waiting time setting 405. After that, when the time that has been set as the time for the printing standby in the ink drying waiting time setting 405 has elapsed, as shown in FIG. 6, the roll sheet 503 is cut by the cutter unit 506. As a result, in the printing apparatus 102, a printed portion 601 is cut off from the roll sheet 503, and sheet feeding and printing for the next print page are performed. It should be noted that when printing is being performed on the roll sheet 503 in the printing apparatus 102, sheet feeding and sheet discharging are performed simultaneously.

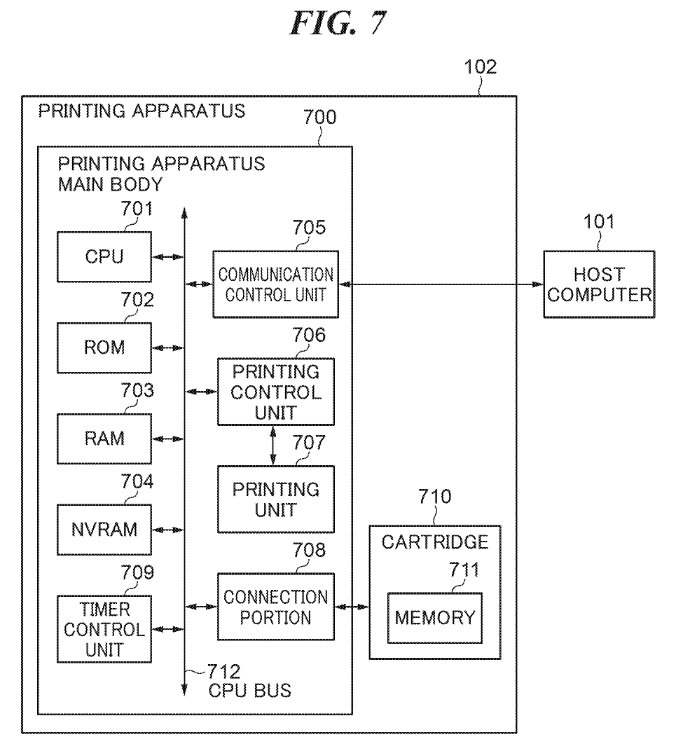

FIG. 7 is a block diagram that illustrates a hardware configuration of the printing apparatus 102. The printing apparatus 102 includes a printing apparatus main body 700. The printing apparatus main body 700 performs a printing operation using a recording material. The printing apparatus main body 700 includes a CPU 701, a ROM 702, a RAM 703, an NVRAM 704, a communication control unit 705, a printing control unit 706, a printing unit 707, and a connection portion 708. The CPU 701 is a system control unit, and controls the entire printing apparatus 102. The ROM 702 stores control execution codes (a program) for the printing apparatus 102. The RAM 703 temporarily stores image data for printing during the control execution of the printing apparatus 102. In addition, the RAM 703 is also used as a working memory or the like when various kinds of programs stored in in the ROM 702 are executed.

The NVRAM 704 is a nonvolatile memory, and stores contract information required for maintenance of the printing apparatus 102, various kinds of data, and information related to images to be printed. The communication control unit 705 controls data exchange with the outside (for example, the host computer 101) via various kinds of interfaces. The printing control unit 706 controls a printing processing performed by the printing unit 707. The printing unit 707 receives a printing command from the printing control unit 706 and performs the printing processing. As a result, the control of the conveying rollers 501, the inkjet head 505, the cutter unit 506, etc. is performed. A cartridge 710, which will be described below, is attached to the connection portion 708. It should be noted that the cartridge 710 includes a memory 711. A timer control unit 709 performs overall timer control for the entire printing apparatus 102. For example, the timer control unit 709 performs the timer control of a printing standby operation and a printing resume operation based on the setting in the ink drying waiting time setting 405 while a printed matter is being formed. The above-described components 701 to 709 are connected to one another via a CPU bus 712 managed by the CPU 701.

The printing apparatus 102 includes the cartridge 710. The cartridge 710 is capable of being attached to the printing apparatus main body 700 and is filled with ink to be used as a recording material. The memory 711 of the cartridge 710 stores first cartridge information for identifying the cartridge 710 and second cartridge information indicating information about an ink remaining amount. The first cartridge information is information indicating a serial number assigned to the cartridge 710 when it is manufactured. The second cartridge information is information about the remaining amount of ink contained in the cartridge 710. The second cartridge information may be expressed by using a volume unit, or may be indicated by a remaining amount level divided by a predetermined threshold value. It should be noted that the cartridge 710 may be any cartridge as long as it is filled with a recording material used for printing and is capable of being detached from the connection portion 708 for replacement. Therefore, the cartridge 710 is not limited to an ink cartridge, and may be, for example, a toner cartridge.

### Display of the print setting screen 400

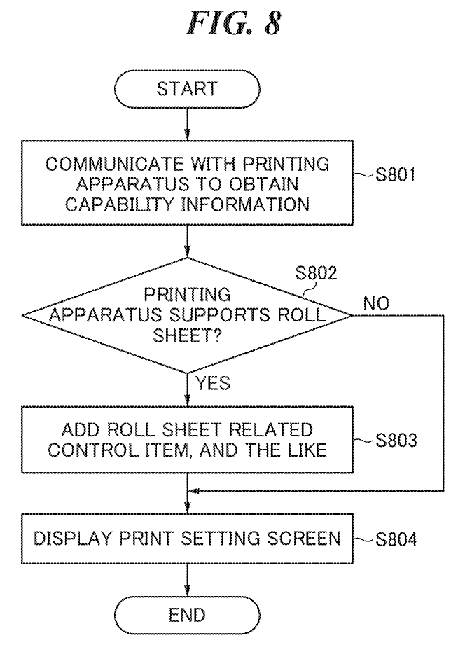

FIG. 8 is a flowchart when the print setting screen extending unit 205 of the extension application 204 performs the display of the print setting screen 400. Respective steps shown in the flowchart (a method) of FIG. 8 are realized by the CPU 111 of the host computer 101 starting up the extension application 204. When the flowchart of FIG. 8 is started, in a step S801, the CPU 111 communicates with the printing apparatus 102 by the print setting screen extending unit 205 of the extension application 204 to obtain capability information.

In a step S802, the CPU 111 determines, by the print setting screen extending unit 205, whether or not the printing apparatus 102 supports a roll sheet. This determination is made based on the capability information that has been obtained in the step S801. In the case where the CPU 111 determines, by the print setting screen extending unit 205, that the printing apparatus 102 does not support a roll sheet (NO in the step S802), the processing proceeds to a step S804, which will be described below. On the other hand, in the case where the CPU 111 determines, by the print setting screen extending unit 205 of the extension application 204, that the printing apparatus 102 supports a roll sheet (YES in the step S802), the processing proceeds to a step S803.

In the step S803, the CPU 111 causes the print setting screen extending unit 205 to add a control item related to roll sheet (the roll sheet width setting 404) to the print setting screen 400. Furthermore, the print setting screen extending unit 205 adds “roll sheet” to a list of setting items for the sheet feeding method setting 403 so that “roll sheet” becomes capable of being set in the sheet feeding method setting 403.

In the step S804, the CPU 111 (a displaying unit) causes the print setting screen extending unit 205 to display the print setting screen 400 on the display unit 120 of the host computer 101 (a displaying step). As a result, in the case where the printing apparatus 102 supports a roll sheet, the print setting screen 400 shown in FIG. 4 is displayed. Therefore, the user becomes able to perform the setting related to roll sheet on the print setting screen 400. After that, the flowchart of FIG. 8 ends.

### Processing performed by the printing apparatus 102

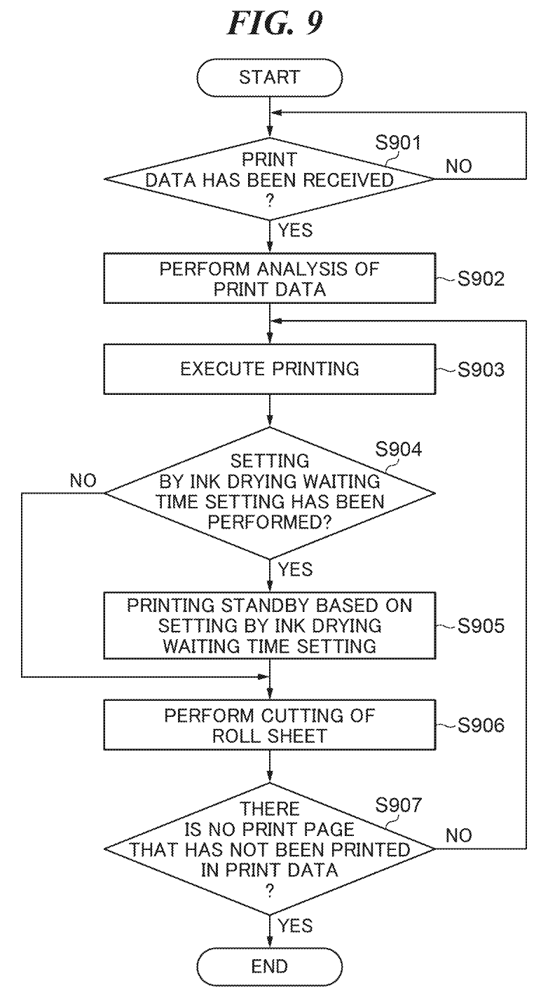

FIG. 9 is a flowchart for illustrating a processing performed by the printing apparatus 102. Respective steps shown in the flowchart of FIG. 9 are realized by the CPU 701 of the printing apparatus 102 reading out a program from the ROM 702, loading the program into the RAM 703, and executing the program. When the flowchart of FIG. 9 is started, in a step S901, the CPU 701 determines whether or not the print data has been received via the communication control unit 705. In the case where the CPU 701 determines that the print data has not been received via the communication control unit 705 (NO in the step S901), the processing returns to the step S901. On the other hand, in the case where the CPU 701 determines that the print data has been received via the communication control unit 705 (YES in the step S901), the processing proceeds to a step S902. In the step S902, the CPU 701 performs the analysis of the print data. At this time, the CPU 701 analyzes the print data to obtain various pieces of information related to printing, including the setting values in the ink drying waiting time setting 405. In a step S903, the CPU 701 causes the printing control unit 706, the printing unit 707, etc. to execute printing.

In a step S904, the CPU 701 determines whether or not a setting in the ink drying waiting time setting 405 has been performed. This determination is made based on the result of the analysis of the print data, which has been obtained in the step S902. In the case where the CPU 701 determines that a setting in the ink drying waiting time setting 405 has not been performed (NO in the step S904), the processing proceeds to a step S906, which will be described below. On the other hand, in the case where the CPU 701 determines that a setting in the ink drying waiting time setting 405 has been performed (YES in the step S904), the processing proceeds to a step S905.

In the step S905, the CPU 701 performs printing standby corresponding to the mode and the time that have been set in the ink drying waiting time setting 405, by using the timer control unit 709 or the like. For example, in the case of the print setting screen 400 shown in FIG. 4, when the time for the printing standby of three minutes has elapsed since the previous cutting, the processing proceeds to the step S906. It should be noted that in the case where there is no previous cutting, when the time for the printing standby of three minutes has elapsed from the start of the flowchart of FIG. 9, the processing proceeds to the step S906. On the other hand, in the case where the inter-scan and “0.5 seconds” have been set in the ink drying waiting time setting 405, printing of one print page is performed while the time for the printing standby while scanning of the inkjet head 505 of the printing apparatus 102 shifts to the next scanning is set to 0.5 seconds. When the printing of one print page is completed, the processing proceeds to the step S906. It should be noted that during the printing standby in the step S905, the roll sheet 503 of the printing apparatus 102 will not be cut.

In the step S906, the CPU 701 causes the printing control unit 706 and other components to perform cutting of the roll sheet. As a result, the roll sheet 503 of the printing apparatus 102 is cut by the cutter unit 506. It should be noted that in the case where a setting in the ink drying waiting time setting 405 has not been performed, when the printing of one print page is completed, the roll sheet 503 of the printing apparatus 102 is cut by the cutter unit 506. It should be noted that cutting of the roll sheet 503 may be performed manually. In addition, in the case where “cut sheet” has been set in the sheet feeding method setting 403, the process of the step S906 is skipped. In a step S907, the CPU 701 determines whether or not there is no print page that has not been printed in the print data. In the case where the CPU 701 determines that there is/are print page(s) that has/have not been printed in the print data (NO in the step S907), the processing returns to the step S903. On the other hand, in the case where the CPU 701 determines that there is no print page that has not been printed in the print data (YES in the step S907), the flowchart of FIG. 9 ends.

As described above, the extension application 204 allows to perform a setting for avoiding the occurrence of malfunctions due to printing using the print data generation software 202 becoming printing of a plurality of print pages, by using the ink drying waiting time setting 405 on the print setting screen 400.

Although the embodiment of the present disclosure has been described above, the present disclosure is not limited to the above-described embodiment, and various modifications and changes are possible within the scope of the gist of the present disclosure. For example, in the present embodiment, the setting for the mode for the printing standby and the setting for the time for the printing standby are performed by the ink drying waiting time setting 405, but only the setting for the mode for the printing standby may be performed by the ink drying waiting time setting 405. In this case, a preset time (for example, three minutes) is used as the time for the printing standby. Alternatively, only the setting for the time for the printing standby may be performed by the ink drying waiting time setting 405. In this case, a preset mode (the inter-page or the inter-scan) is used as the mode for the printing standby.

In addition, in the ink drying waiting time setting 405, as the setting for the mode for the printing standby, either the setting for the inter-page or the setting for the inter-scan is performed, but both the setting for the inter-page and the setting for the inter-scan may be performed. In this case, as the setting for the time for the printing standby, both a setting for the inter-page (for example, 3 minutes) and a setting for the inter-scan (for example, 0.5 seconds) are performed. It should be noted that in the case where the printing apparatus 102 is a printer that executes printing by using an electrophotographic method using toner, the modes for the printing standby that are capable of being set in the ink drying waiting time setting 405 are the inter-page and the printing apparatus setting priority, but not include the inter-scan.

According to the present disclosure, it is possible to perform a setting for avoiding the occurrence of malfunctions due to printing using a standard driver becoming printing of a plurality of print pages.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016154, filed February 3, 2025, which is hereby incorporated by reference herein in its entirety.

What is claimed is:

1. A non-transitory computer-readable storage medium storing an application program, a method being executed by executing the application program by a computer of an information processing apparatus, the method comprising:
supporting a standard driver provided by a provider of an operating system of the information processing apparatus, the standard driver generating print data which is printable by printers of a plurality of printer makers; and
causing a display of the information processing apparatus to perform display of a screen for receiving a setting of a time for printing standby to be performed after start of printing based on the print data.

2. The non-transitory computer-readable storage medium according to claim 1, wherein
the time is a time for the printing standby before completion of the printing based on the print data.

3. The non-transitory computer-readable storage medium according to claim 1, wherein
the display is caused to perform display of the screen by using information from a printing apparatus that executes the printing using the standard driver.

4. The non-transitory computer-readable storage medium according to claim 1, wherein
the time is a time a time by which the printing standby is performed while a print page shifts to a next print page.

5. The non-transitory computer-readable storage medium according to claim 1, wherein
the time is a time by which the printing standby is performed while scanning of an inkjet head shifts to a next scanning.

6. The non-transitory computer-readable storage medium according to claim 1, wherein
the time is a time between a time when cutting of a roll sheet used by the printing ends and a time when a next cutting starts.

7. The non-transitory computer-readable storage medium according to claim 1, wherein
the time is a time between a time when sheet discharging of a roll sheet used by the printing ends and a time when a next sheet discharging starts.

8. A method performed by executing an application program by an information processing apparatus, the method comprising:
supporting a standard driver provided by a provider of an operating system of the information processing apparatus, the standard driver generating print data which is printable by printers of a plurality of printer makers; and
causing a display of the information processing apparatus to perform display a screen of a time for printing standby to be performed after start of printing based on the print data.

9. An information processing apparatus, comprising:
a memory that stores an application program; and
a processor that causes, by executing the application program stored in the memory, the information processing apparatus to:
support a standard driver provided by a provider of an operating system of the information processing apparatus, the standard driver generating print data which is printable by printers of a plurality of printer makers; and
cause the information processing apparatus to perform display of a screen for receiving a setting of a time for printing standby to be performed after start of printing based on the print data.
